(19) United States
(12) Patent Application Publication
(10) Pub. No.: US 2003/0118308 A1
(43) Pub. Date: Jun. 26, 2003

(54) Thermal compensation and alignment for optical devices

(76) Inventor: Terry Bricheno, Great Sampford (GB)

Correspondence Address: William M. Lee, Jr., LEE, MANN, SMITH, MCWILLIAMS, SWEENEY & OHLSON, P. O. Box 2786, Chicago, IL, 60690-2786, US

(21) Appl. No.: 10/032,421

(22) Filed: Dec. 21, 2001

(51) Int. Cl. G02B 6/10; G02B 6/12; G02B 6/26; G02B 6/34

(52) U.S. Cl. 385/129; 385/14; 385/46; 385/37

(57) ABSTRACT

An arrayed waveguide device has an expansion rod for adjusting a position of the optical paths at a star coupler, by thermal expansion, to compensate for wavelength response dependence on temperature. A bearing surface parallel to a plane of the waveguides prevents movement out of the plane and allow movement along the bearing surface parallel to the plane. Thus small lateral movements can occur accurately without introducing losses through unwanted vertical movements using a passive mechanical arrangement. It a be used together with active thermal control, to give better compensating accuracy, or compensation for manufacturing variations. An optical component assembly has a substrate having one or more mating profiles, and first and second planar waveguide chips having mating profiles. During assembly, the mating profiles enable passive alignment of an optical coupling between is respective waveguides of the chips. A groove locates a fiber on the chip using passive alignment.

### FIELD OF THE INVENTION

This invention relates to planar waveguide devices, having an adjuster operable by thermal expansion, to optical components having adjusters using thermal expansion, to corresponding methods, to systems incorporating such components, to methods of offering a telecommunications service over a network having such systems, to optical component assemblies having alignment or mating profiles, to optical flat-topped filter arrangements, to optical waveguide assemblies having transitional waveguides, to methods of assembling such apparatus, and to methods of manufacturing planar waveguides with integrated profiles.

### BACKGROUND TO THE INVENTION

It is well known that many optical components need to be thermally stabilized (also termed “athermalization” ) so that their optical characteristics do not change with ambient temperature changes. This is particularly important for devices which rely on small differences in optical path length, using diffractive or refractive effects, including arrayed wave guide grating (AWG) filters, Mach-Zehnder type devices and so on. The largest component of temperature sensitivity is usually the refractive index of the waveguide material. As optical systems are designed with more and more demanding specifications, thermal stabilization becomes more important. For AWG devices, the temperature dependence manifests itself as movement of position of a waveguide image in the focal plane of the AWG star coupler. This causes the wavelength response to shift sufficiently to degrade filtering performance, particularly for high performance dense WDM (wavelength division multiplexed) systems having narrow and closely spaced channels.

Several different solutions have been proposed. Active thermal control using heaters and coolers is expensive, complex, and hard to make reliable. Various arrangements for passive thermal compensation have been tried. For example, a paper entitled

“Athermal Silica based AWG multiplexers with new low loss groove design” by Kaneko et al, conference publication ref TuO1-3, p204-206, shows inserting multiple lateral grooves across the waveguides. The grooves contain a silicone material of opposing thermal characteristics to those of the rest of the waveguides. The result is that the effective optical path length is nearly insensitive to temperature The problem with this approach is the loss introduced by the multiple grooves. A similar principle is shown in U.S. Pat. Nos. 6,181,848 and 6,169,838. Another attempt at passive thermal compensation is shown in WO9921038, which uses a cladding for the waveguide having different thermal characteristics. Problems with this approach include extra processing steps, and the process control which limits accuracy. EP1072908 shows using a backplate to cause the waveguide to warp, the resulting compression of the waveguides providing a compensating change in refractive index, and thus in optical path length However, this approach brings problems such as the reliability of the stressed substrate and variation over a typical 25 year life as stresses relieve. Also, there is associated stress birefringence in a pwg (planar waveguide) device.

A more accurate and low loss athermalization scheme is shown in principle in a paper entitled “optical phased array filter module with passively compensated temperature dependence” by Heise et al, presented at ECOC '98, 20-24 Sep. 1998. As shown in FIG. 1, tis involves using thermal expansion of a rod to move the lateral position of an input optical filter, at the input to a star coupler. Changing the lateral point of entry of the optical path to the star coupler, changes the centre wavelength of the filter. By choosing an appropriate length and material for the expansion rod, this change in centre wavelength can cancel out the temperature sensitivity of the rest of the device.

However, the amounts of movement are so small, in the order of microns, and the requirements for accuracy are so demanding, that realizing an implementation that is practical for production is the real problem and this is not discussed in the paper.

The sort of accuracy tat is needed for a 50 GHz spaced DWDM (Dense wavelength division multiplexed) system is 1-2 GHz variation over 100 K temperature variations. This involves a positional accuracy of tens of picometres. Achieving this degree of accuracy in a device which has to meet 500 G shock tests, have a 25 year life-span, and yet be reproducibly and cheaply produced, is a formidable task.

A related problem is that of achieving correct alignment of optical interfaces when physically assembling optical components into any sort of subassembly or system. The types of interface which are sensitive to alignment include fiber to planar waveguide (PWG), PWG to PWG interfaces, and laser or detector to fiber or PWG interfaces. These examples can be summarised as fiber to chip and chip to chip interfaces.

Known techniques for implementing such alignment include passive alignment, and various types of active alignment. One notable type is described in U.S. Pat. No. 5,574,811 to Parker and Bricheno. This shows aligning a laser and a fiber using a special platform (termed a “flipper”)which as an etched V-groove for locating the fiber, and rails and grooves for mating witch complementary surfaces on a substrate. As preliminary steps, the laser is bonded to the substrate, and the fiber is bonded in the V-groove of the platform. The platform with the fiber bonded to it is then placed on the substrate using the rails and grooves to provide passive alignment typically to within 10 micromentres. Active alignment using a test optical signal, and measuring the optical loss across the interface for different positions, is then used to provide finer alignment. Then glue is inserted by capillary action into the narrow gap between the complementary grooves and rails of the substrate and the platform. Therefore this “flipper” process can be seen as using a coarse passive alignment followed by a simplified active fine alignment.

There are a number of key benefits over other active alignment processes such as those involving aligning using a six-axis alignment set up, then glueing. First the alignment is only two axis, which is much easier, quicker and cheaper, and secondly aligning the fiber in the V-groove is relatively easy. Thirdly the thickness of glue is always small, and so problems of shrinkage of the glue during curing, or long term instability or temperature dependence of the glue, are minimised. Also, the process is easily adapter for use with ribbon fiber.

This has been used successfully for coupling fiber to planar waveguides. However, for an optical assembly having two or more planar waveguides mounted on a substrate, the alignment of these waveguides presents problems. If the flipper process were to be used, it might involve a flipper for attaching and aligning a fiber to the first PWG, then another flipper for attaching this assembly to the second waveguide. This creates a “stack” of flippers, waveguides and spacers which is unwieldy and impractical.

Attempts to make the flipper as part of a planar waveguide rather than a separate piece, so as to reduce the number of parts, and thus reduce the size of such a stack, have met with manufacturing problems. Some of the manufacturing problems will now be explained briefly.

A conventional PWG process involves growing thermal oxide on both sides of a silicon substrate, as a buffer, then depositing a waveguide core material, patterning it using a photo resist. A cladding layer for covering the waveguide core is then created by deposition and reflow. If this were to be modified to create the V-grooves first in she silicon (Si) substrate, the topography of the grooves would cause problems with the subsequent step of spinning of the photo resist and therefore interfere with the definition of the waveguide components when these are patterned by photolithography. If the grooves are produced last, creating a mask for forming the grooves afterwards is difficult. This is because of the presence of oxide layers created on the silicon substrate. A necessary precursor stage to the etching of the Si involves a short etch in eg buffered HF (Hydrofluoric acid) in order to remove any traces of oxide from the surface of the Si to be etched. This HF etch would impair the definition of an oxide mask for v-groove definition.

### SUMMARY OF THE INVENTION

It is au object of the invention to provide improved apparatus add methods.

A first aspect of the invention provides a planar waveguide device having one or more optical paths passing through a star coupler, and a set of waveguides having differing optical path lengths extending from the star coupler, the device also having a moveable part for adjusting a position of one or more of the optical paths at the star coupler, by thermal expansion, to adjust a wavelength response of the device, the device having a bearing surface parallel to a plane of the waveguides at the star coupler, to prevent movement of the moveable part out of the plane and allow movement along the bearing surface parallel to the plane.

This enables the very small lateral movements to occur accurately without introducing losses through unwanted vertical movements. It does so with a passive mechanical arrangement which can avoid the expense of more complex arrangements. Where it enables the device to be packaged without an active thermal control section, then associated costs of hermetically sealed packaging can also be avoided. Other advantages can arise if used together with active thermal control, including better compensating accuracy, or compensation for manufacturing variations.

Preferably the device is arranged to receive an optical fiber to form one of the optical paths, the moveable part being arranged to move the optical fiber, relative to the star coupler, the movement being transverse to a longitudinal as of the fiber.

Preferably the moveable part has a planar waveguide chip to form one or more of the optical paths.

Preferably the movement is lateral movement in the plane and perpendicular to the respective optical path, to alter the position of interface of the optical path with the respective star coupler.

Preferably the amount of the movement by thermal expansion is arranged to cause sufficient change in the wavelength response to compensate for other thermally induced changes in the wavelength response of the device

Preferably the device has a bearing surface parallel to a plane of the waveguides at the star couplers, to prevent movement of the movable part out of the plane and allow movement of the moveable part along the bearing surface parallel to the plane, and a bias arrangement for applying a force to bias the moveable part against the bearing surface.

Preferably the device has a reference surface for the thermal expansion to act against, to cause the relative movement, and an axial bias arrangement for applying a force along an axis of the movement to bias the moveable part against the reference surface, to overcome mechanical hysteresis associated with frictional resistance to the movement.

Another aspect of the invention provides a planar waveguide device having

one or more optical paths passing through a star coupler, and a set of waveguides having differing optical paths lengths extending from the star coupler,

the device also having a movable part for adjusting a position of one or more of the optical paths at the star coupler, by thermal expansion, to adjust a wavelength response of the device,

the device having a bearing surface parallel to a plane of the waveguides at the star coupler, to prevent movement of the movable part out of the plane and allow movement of the moveable part along the bearing surface parallel to the plane, and a bias arrangement for applying a force to bias the moveable part against the bearing surface.

Yet another aspect provides a planar waveguide device having:

one or more optical paths passing trough a star coupler, and a set of waveguides having differing optical path lengths extending from the star coupler, the device also having a movable part for adjusting a position of one or more of the optical paths at the first or second star coupler, by thermal expansion, to adjust a wavelength response of the device, the device having a reference surface for the thermal expansion to act against, to cause the relative movement, and an axial bias arrangement for applying a force along an axis of the movement to bias the moveable part against the reference surface, to overcome mechanical hysteresis associated with frictional resistance to the movement,

Another aspect provides an optical component having an optical path that varies with temperature and having an adjuster, the adjuster having

a movable portion of the optical path,

an expansion member coupled to the moveable portion to move it by thermal expansion, relative to a reference surface,

a guide for guiding the movement of the expansion member, and

a bias arrangement for biasing the moveable portion against the guide.

Another aspect provides a method of operating an optical telecommunication network to offer a telecommunications service to subscribers by transmitting optical signals along an optical path passing through the above optical component. This aspect recognises the value of the services which may be carried by the component as a critical part of a system in use. The value of these services may be many times greater than the cost price of the apparatus, and is enhanced by the advantages of the component.

Another aspect provides an optical component assembly having:

a substrate having one or more alignment profiles, and

first and second planar waveguide chips mounted on the substrate,

at least the first of the planar waveguide chips having:

one or more alignment profiles corresponding to those on the substrate for cooperating with the alignment profiles on the substrate, for alignment of an optical coupling between respective waveguides of the first and second planar waveguide chips, and a groove for locating a fiber for providing an optical coupling to or from the assembly.

Preferably the first of the chips (or mini chips) has waveguide elements which are all sufficiently short or simple that they are not susceptible to variations across different areas of the chip, of a propagation constant of the waveguide, such variations being sufficient to cause degradation of precision interference or diffraction effects relying on long optical paths across the different areas of the chip. Examples of such simple waveguide elements include routing waveguides or MMI (Multi Mode Interference) devices. These variations may be an unwanted by-product of manufacturing processes, such as those described below for chips with integrated profiles. Uneven formation of the waveguide over a large chip area may give rise to random phase errors. Simple waveguide elements may tolerate phase errors caused by variations of 1 part in 1000 in the propagation constant, whereas large precision waveguides may be degraded significantly by variations of 1 part in a million.

Preferably the second of the planar waveguide chips has one or more optical paths passing through a first star coupler, a second star coupler, and a set of waveguides having differing optical path lengths extending between the first and second star couplers.

Another aspect provides an optical flat-topped filter arrangement having:

an arrayed waveguide chip for multiplexing or demultiplexing a wavelength division multiplexed (WDM) signal, and having a star coupler, a second chip incorporating a multimode (MMI) section coupled in series with the arrayed waveguide, and providing a spatial power distribution that convolves with that of the arrayed waveguide to give a flat-topped overall response for each of a number of WDM channels, and

a passive mechanical thermal compensation arrangement for providing a thermal expansion-driven relative movement between the arrayed waveguide chip and the MMI chip, to shift a location of an input or output to the star coupler of the waveguide, so as to shift its frequency response. An advantage of this combination is that better thermal performance and/or lower costs can be achieved.

Preferably the multimode chip has one or more alignment profiles for cooperating with corresponding alignment profiles on a substrate of the thermal compensation arrangement, for alignment during assembly.

Another aspect provides an optical waveguide assembly having an arrayed waveguide, and a transitional waveguide coupled optically to the arrayed waveguide and mounted on separate chips on a substrate and having a passive athermalisation arrangement for the arrayed waveguide. An advantage of this combination is that significant cost reduction can be achieved, and better athermalisation or simpler thermal control with less precise and therefore cheaper active control can be achieved.

Preferably the athermalisation arrangement has a moveable part for adjusting a lateral alignment of the separate chips by thermal expansion, to adjust a wavelength response of the arrayed waveguide.

Preferably the transitional waveguide is mounted on the moveable part, the transitional waveguide and the moveable part having mating profiles for passive alignment during assembly.

Another aspect provides a method of method of assembling an optical component assembly having a substrate, and first and second chips each having waveguides, the first of the chips having one or more first mating profiles, for mating with one or more second mating profiles on the substrate or on a spacer or movable part attached to the substrate, the method having the steps of:

attaching the second chip to the substrate, with a coarse alignment process, to align the second chip with the second profiles and making a coarse alignment of the first chip with the second chip by mating the first and second mating profiles. An advantage of this is the coarse alignments enable a significant cost and or time reduction in manufacturing, since they can make subsequent fine alignments much easier, or even unnecessary.

Preferably the method additionally has the step of attaching a fiber to the first or the second chip, using an alignment groove on the respective chip to locate the fiber for passive alignment with the waveguide of the respective chip.

Preferably the method additionally has the step of caring out an active alignment process for the first and second chips when attaching the first chip to the substrate or spacer.

Preferably the matching mating profiles are positioned and fixed after the second chip has been attached, the aligning of the second chip and the matching mating profiles involving forming the profiles in alignment with the waveguide of the second chip.

Preferably the first chip has simple waveguide elements which are all short or simple.

Another aspect of the invention provides a method of manufacturing a planar waveguide having one or more integrated profiles for alignment of the waveguide with a fiber or another waveguide, the method having the steps of: forming a first mask on a substrate, the first mask being patterned for later forming the integrated profiles, forming waveguides on a different part of the substrate, uncovering the pattern of the first mask by etching using a reactive ion etching (RIE) type etching step and a fine wet-etching step, and forming the integrated profiles through the first mask.

An advantage of this two stage etching to uncover the first mask is that it can uncover effectively with minimal damage to other parts, thus facilitating making a mini chip or transitional waveguide for use in the above assemblies.

Preferably the step of forming the waveguides has the step of forming an oxide layer using a deposition process.

Preferably the step of forming the waveguides involves leaving a margin between an edge of the waveguides and a facing edge of the pattern for the integrated profiles.

Preferably part of the margin is removed to expose an end of the waveguide facing one of the integrated profiles to enable optical coupling between the end and an optical fiber laid in that profile.

Another aspect provides a method of manufacturing a planar waveguide having one or more integrated profiles for alignment of the waveguide with a fiber or another waveguide, the method having the steps of: forming a first mask on a substrate, the first mask being patterned for later forming the integrated profiles, forming waveguides on a different part of the substrate leaving a margin between an edge of the waveguides and a facing edge of the pattern for be integrated profiles, forming the integrated profiles through the first mask, and removing part of the margin to expose an end of the waveguide facing one of the integrated profiles to enable optical coupling between the end and an optical fiber laid in that profile. An advantage of providing this margin is that damage to the waveguide during formation of the profiles can be reduced or avoided.

Another aspect provides a method of manufacturing a planar waveguide having one or more integrated profiles for alignment of the waveguide with a fiber or another waveguide, the method having the steps of: forming a first mask on a substrate, the first mask being patterned for later forming the integrated profiles, and being formed of a material capable of withstanding etching and high temperature processing, forming waveguides on a different part of the substrate, by depositing oxide layers over the nitride layer, uncovering the pattern of the first mask, and forming the integrated profiles through the first mask.

An advantage of using this type of material for the first mask, is that damage from later processing steps can be reduced or avoided. Nitride is one example of a suitable material. Later processing steps can include a precondition etch using HF or buffered HF for removing oxide from the silicon which otherwise interferes with the silicon etch to form islands. Another later processing step can be high temp deposition of waveguide layers and subsequent annealing steps.

Other advantages may be apparent to those skilled in the art, particularly over other prior art not known to the inventor. Any of the preferred features may be combined with each other or with other aspects of the invention, as would be apparent to those skilled in the art.

### BRIEF DESCRIPTION OF THE DRAWINGS

The invention and how to put the invention into practice will now be described by way of example with reference to the figures in which:

FIG. 1 shows a known principle for athermalising an AWG,

FIGS. 2A to 8 show embodiments of the invention for implementing the principle shown in FIG. 1,

FIGS. 9 and 10 show known arrangements for coupling a fiber to a waveguide,

FIGS. 11 and 12 show embodiments of the invention for coupling fiber or a chip to the expansion rod of the above athermalisation arrangement,

FIGS. 13A-13D show steps in making the assembly of FIG. 12,

FIGS. 14-16 show examples of the mini-chip shown in FIGS. 12 and 13, and

FIGS. 17A-17G show steps in manufacturing the mini-chip.

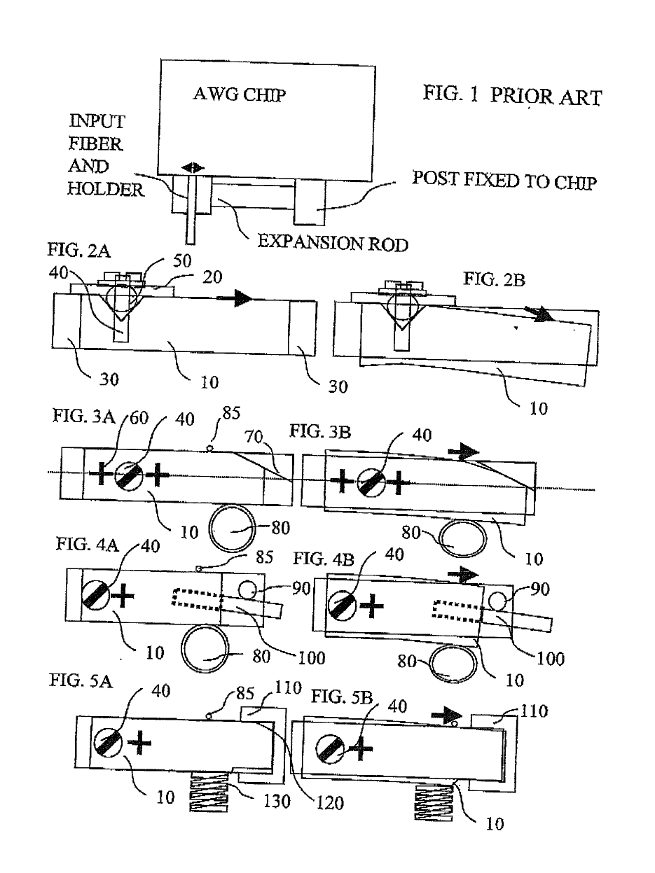

### DETAILED DESCRIPTION

FIGS. 2A 2B

FIG. 2A shows in schematic form a side view of part of a first embodiment of the invention to explain some of the problems addressed by the invention. It shows an expansion rod 10 fixed at one end to a plate 20 which is in turn fixed to a substrate 30 for supporting the AWG chip, located behind the expansion rod in this view. The plate provides a vertical reference to align the top surface of the expansion rod with the top surface of the substrate 30 for the chip. A screw 40 is provided to attach the expansion rod to the plate. A ridge 50 is provided on the undersurface of the plate, as a horizontal reference for accurately locating the left hand (fixed end) of the expansion rod. A corresponding V-shaped notch is provided in the expansion rod to fit the ridge of the plate. The screw serves to pull the expansion rod against the plate and to pull the ridge into the corresponding notch, to provide accurate vertical and horizontal positioning of the left hand end of the expansion rod.

The right hand end of the expansion rod is free to move horizontally relative to the chip by thermal expansion or contraction. A fibre can be attached to a top surface of the right hand end of the expansion rod to achieve the desired movement. However, as shown in FIG. 2B, when thermal expansion occurs the resulting movement of the top surface of the right hand end is not only horizontal. There is sufficient vertical component of movement to disrupt the operation of the device.

FIGS. 3A to 8, Expansion Rod Configurations.

FIGS. 3A to 8 show various configurations according to embodiments of the invention for controlling or avoiding the vertical component of movement. They are concerned with providing a fixing at the left hand end which gives a good reference location, and at the same time minimising friction-related errors in the horizontal movement resulting in poor thermal compensation performance, and minimising any vertical component of movement. Finally, another design constraint was the desire for low cost and therefore ease of assembly by machine or relatively unskilled labour Where feasible, corresponding reference numerals have been used for features repeated in these figures.

FIG. 3A shows at the left hand end of the expansion rod a screw fixing having a horizontal axis rather than the vertical axis of the screw of 2A. A pair of dowels 60 are provided on each side of the screw along the centre line of the expansion rod. These dowels extend into the substrate of the chip to provide a solid reference for the relative movement caused by the thermal expansion. To constrain vertical movement, a gently sloping bearing surface 70 is provided fixed near the top surface of the chip and extending out over the top surface of the expansion rod. The expansion rod is biased against this bearing surface by a resilient tube 80 which presses on the bottom surface of the right hand end of the expansion rod.

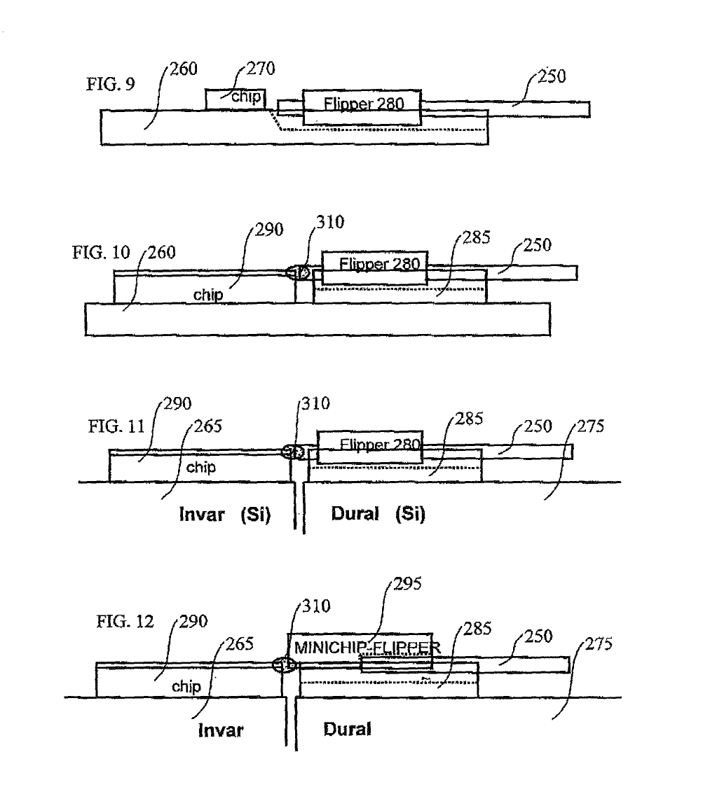

The sloping bearing surface is arranged so that as the right hand end of the top surface of the expansion rod slides along the bearing surface as the expansion rod expands, the slope provides a downward component of movement, as shown in FIG. 3B. This can compensate for an upward component of movement caused by expansion The gradient of the slope can be carefully chosen depending on the dimensions and material characteristics of the expansion rod, and the fixings, so as to accurately minimise any vertical movement. The top surface of the right hand end of the expansion rod may be formed with a slope corresponding to the slope of the bearing surface to provide al larger area of bearing surface, to reduce wear and therefore maintain accuracy over an extended life span. This figure also shows the fibre 85 located on the top surface of the expansion rod. In principle it could be located on the bottom surface or anywhere else on the right hand end. It can be fixed by a conventional bonding process. An example is a V-groove process, or the above mentioned flipper process, discussed in more detail below with reference to FIG. 9 onwards.

In FIGS. 4A and 4B a similar effect is achieved by replacing the sloping bearing surface with a dowel 90 fixed to the chip and extending horizontally across the right hand end of the expansion rod. The vertical movement compensation is achieved by providing another dowel 100 extending from the end of the expansion rod and sloping gently downwards at the same carefully calculated angle. The top surface of the sloping dowel bears against the bottom of the horizontal dowel and therefore as it slides under the horizontal dowel with thermal expansion, there is a downward component of movement. Again, a biasing member such as a resilient tube 80 is provided to keep the two dowels in contact. The reference fixing is provided by a horizontal screw as before and a single horizontal dowel on the centre line of the expansion rod. This can help avoid complex movements during expansion, caused by stresses between the two dowels.

In FIGS. 5A and 5B, the same reference fixing is used, but with a different arrangement at the right hand end for constraining vertical movement. A bar 110 fixed to the chip substrate 30 extends over the top surface of the right hand end of the expansion rod. This provides a fixed vertical reference bearing surface 120 in a plane parallel with the top surface of the chip. It is provided at the end of the expansion rod so that the fibre is located in between the reference fixing at the left hand end and the vertical reference bearing surface. Hence any residual vertical movement at the right hand end will appear as a smaller vertical movement of the fibre. A resilient member such as the spring 130 biases the expansion rod upwards against the vertical reference bearing surface. In this case no slope is provided. The fibre is located close to the vertical reference bearing surface. The bar is conveniently formed with a C profile arranged to wrap around the right hand end of the chip. This adds to its rigidity and the ease of fixing it firmly to the chip. Only the surface used as the vertical reference bearing surface need be accurately machined.

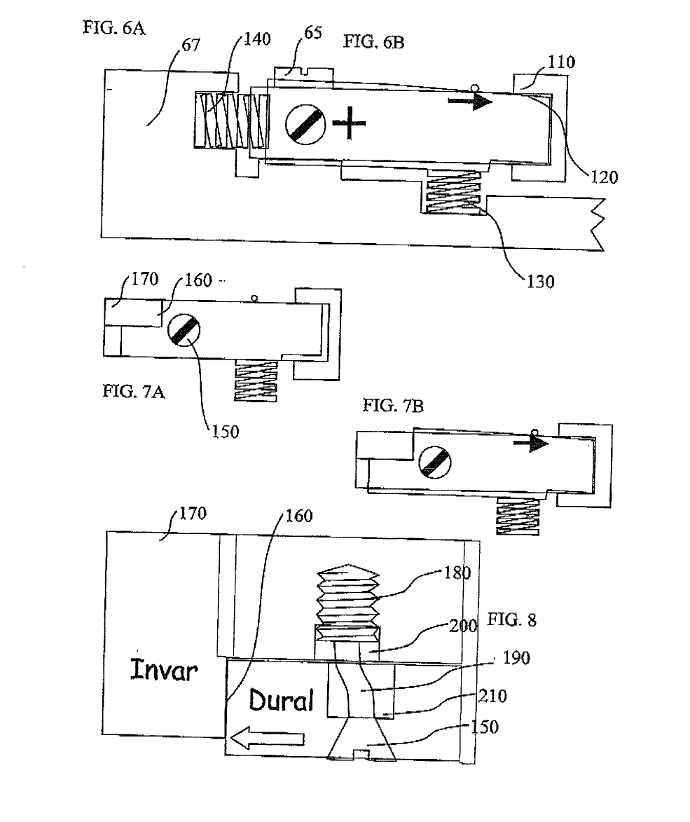

FIG. 6 shows another configuration using the same bar 110 and the same resilient member 130, to bias the expansion rod against the vertical reference bearing surface. An additional horizontal bias element in the form of a spring 140 is provided to bias the left hand end of the expansion rod against the dowel 60. This serves the purpose of overcoming mechanical hysteresis associated with friction between the expansion rod and the vertical reference bearing surface. In principle it would be conceivable to provide other ways of overcoming such hysteresis, by reducing the friction Conventional friction measures such as lubrication or surface treatments or rolling bearings could be used. The bias member as shown in this figure has the advantages of being low cost, simple to assemble and providing predictable performance over a long life span with no maintenance, compared to other measures. FIG. 6 also shows a vertical screw 65 for retaining the assembly in a housing 67.

FIGS. 7A and 7B show another configuration which differs from FIG. 6 in that the dowel and the horizontal bias element have been replaced by a new horizontal fixing screw 150 which achieves the same functions. It does this by means of a slightly tapered hole in the expansion rod and a horizontal reference surface 160 on a block 170 formed as part of the chip. The left hand end of the expansion rod is biased against this horizontal reference surface by the insertion of the screw into the tapered hole, which is deliberately located off centre compared to the corresponding screw hole in the chip. The off centring is directed away from the reference surface. This and the tapering of the hole contribute towards the expansion rod being biased horizontally against the reference surface of the block when the screw is inserted. The tapering enables the bias force to be controlled according to the force of insertion of the screw. By arranging the horizontal reference surface to extend from the centre line to the top surface of the expansion rod, there is considerable self-compensation for vertical movement. Accordingly, the vertical bias force can be reduced, and hysteresis and the loss of accuracy resulting from such hysteresis can be reduced.

FIG. 8 shows a cross section of the screw 150 in plan view. It has a threaded section 180 for threading into a hole in the body of the substrate 170. The screw also has a straight shank section 190 which is shown deformed or strained laterally because of the off-centring of the hole in the dural expansion rod. Two key features are the precise dimension of the offcentring of the holes, carefully calculated to give the desired bias force, and the steep gradient of the tapering of the countersunk section of the hole in the expansion rod. By making this tapering steep, more force is directed laterally as the screw is tightened. A third key feature is the provision of a larger diameter clearance section for part 200 of the hole in the substrate, and a similar part 210 of the hole in the expansion rod The lenghts of these clearance parts can be carefully chosen to minimise changes of the bias force with temperature. The lengths can be chosen so that the expansion with temperature of the dural in the direction parallel to the axis of the screw, matches the axial expansion of the shank in the clearance parts This helps keep the lateral bias force constant, without complex or costly mechanical arrangements or other thermal controls.

The waveguides may have silica cores or silicon cores, or other materials. The dependence of the optical characteristics with temperature will be different for different materials, and so the length of the expansion rod can be determined accordingly, to achieve complete compensation.

If desired, the compensation need not be precise, any amount of compensation will serve to leave a reduced temperature dependence which could be tolerated or compensated in another way. For example active thermal control of the waveguide could be provided as well as the passive mechanical compensation shown above. This could involve providing a heater or cooler just for the waveguide, or for the entire package for example. An advantage of the combination of active and passive control, is that it cat reduce the required precision of the passive mechanical compensation, and reduce the required precision of the active control. Another variation would be to use the mechanical compensation in association with active control of the temperature of just the expansion rod. In this way, the optical characteristics of the waveguide can be actively controlled during use. This could enable optimisation for higher performance, it could be a path for a future upgrade of a component instead of replacing it in mid-life. It could also be used to relax the manufacturing tolerances of the chip, and so enable a greater yield of workable chips from each wafer, and thereby reduce the cost of each chip.

Files 9 to 13 Flipper and Mini Chip Aspects.

FIG. 9 shows a conventional arrangement of a fiber 250 aligned to a chip 270 such as a PWG device, by using the flipper process. The chip is first attached to a substrate 260 or motherboard or other reference surface. Alignment grooves are made in the substrate, located accurately, ready to receive the flipper 280. The flipper has grooves on a bottom surface for fitting those on the substrate, and a V-groove in a top or bottom surface, to fit the fiber. The fiber is passively located and glued in the V-groove, then the flipper with the fiber is lowered onto the substrate and located accurately using the grooves in the substrate. Final alignment to achieve greater accuracy is achieved by an active alignment before glueing the flipper to the substrate.

The configuration of FIG. 10 is also conventional and shows the flipper arrangement adapted for chips 290 having a waveguide on their top surface. In this case, to match the heights, a rail 285 is used as a spacer for raising the flipper off the surface of the substrate. The rail has the grooves to match those on the underside of the flipper. Also shown is the index matching material 310 for filling the gap between the end of the fiber, and the start of the waveguide on the chip.

FIG. 11 shows an embodiment of the invention, combining the flipper with a mechanical thermal compensation arrangement. The flipper is used to attach the fiber to the expansion rod 275 made of dural. The rod is fixed to the invar substrate 265 at one end, and free to move with thermal expansion at the other end, as shown in FIGS. 2 to 8. As the movement should be transverse to the fiber, this would be in a direction normal to the page in the view of FIG. 11. Hence for the sake of clarity, the fixing, reference surface and biasing arrangement have not been shown in FIG. 11. An advantage of using the flipper process for attaching the fiber to the thermal compensation arrangement is that it reduces the cost and simplifies manufacture, since most of the alignment is achieved passively, relying on the accuracy of the manufacture of the grooves. A final accurate more accurate alignment can be made using an active process. The flipper combines with the thermal compensation mechanism neatly to contribute to ease of manufacture of a high precision optical component.

For this embodiment, clearly the index matching material needs to be sufficiently flexible to remain in place and attached to both the fiber and the chip even after many thousands of expansion and contraction movements. There are silicone based materials available with extremely low elastic modulus values to meet this requirement.

FIG. 12 shows another embodiment of the invention which differs from that of FIG. 11 in that the flipper is in the form of a transitional chip or mini chip 295 having a waveguide with integrated profiles. This enables multi chip assemblies to be constructed and aligned more easily. In this case the waveguide is shown on the bottom of the flipper though other arrangements are conceivable. Although shown on a mechanical thermal compensation arrangement, it can equally be applied to multiple chips located on a fixed substrate as in FIG. 10 for example. An advantage of being able to separate optical processing functions on to more the one chip, is that larger chips are harder to manufacture, and thus more expensive. This is particularly the case with more advanced chips having higher performance, which tend to be harder to manufacture, leading to lower yields. Up to now, the cost of aligning these chips with sufficient accuracy at the time of manufacture has been a significant constraint.

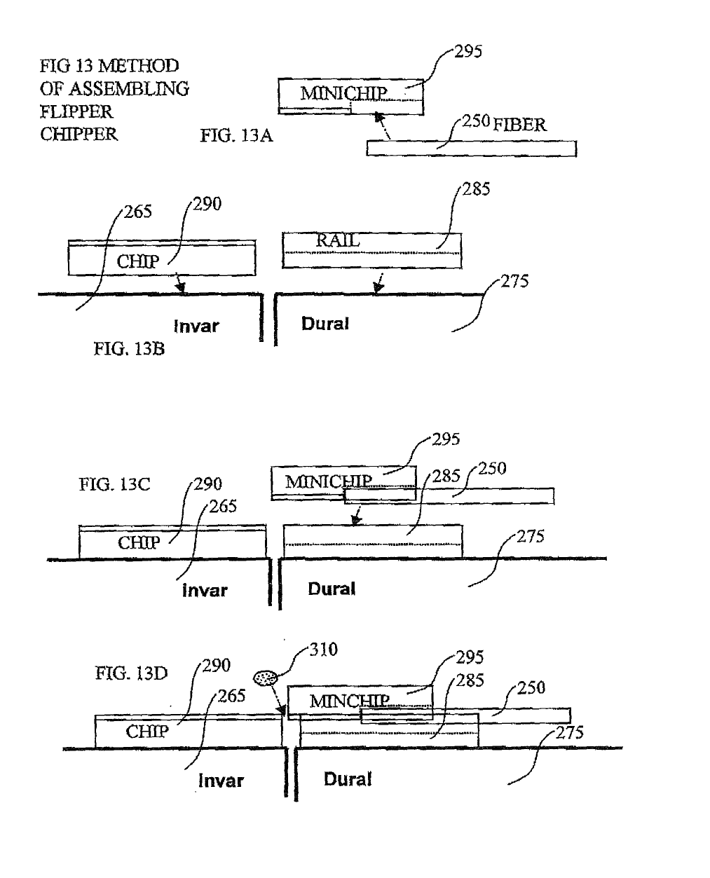

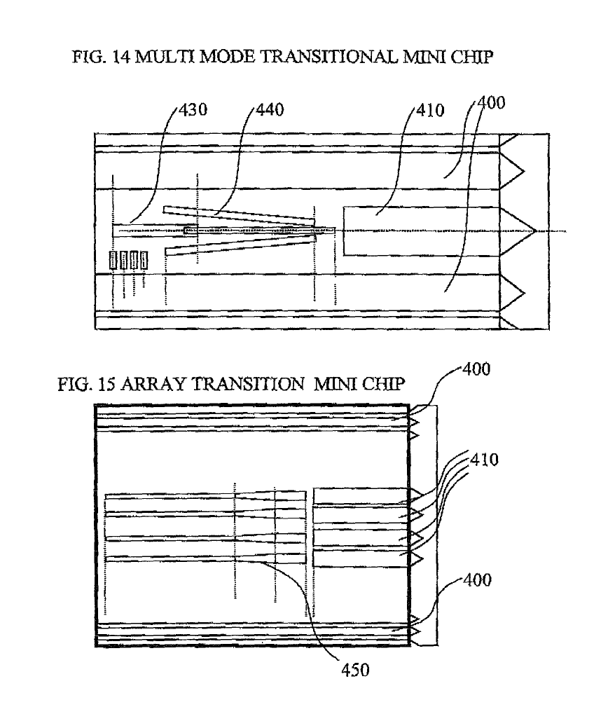

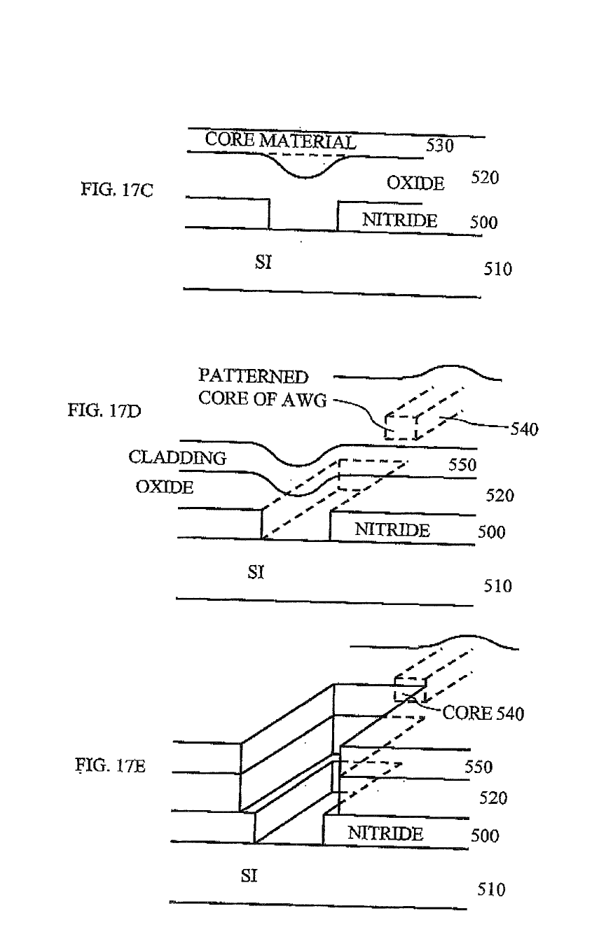

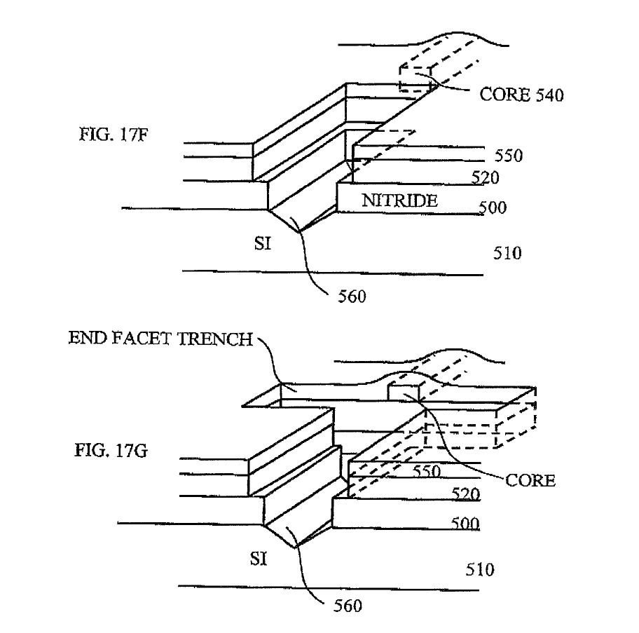

Having a separate chip between the fiber and the PWG or AWG is particularly useful for a number of “transitional” optical functions as will be described in more detail below with reference to FIGS. 14, 15 and 16. A method of assembling the elements will be described with reference to FIGS. 13A-D, while a method of manufacturing the flipper incorporating the waveguide chip will be described below with reference to FIGS. 17A-G.

FIG. 13A shows the step of attaching the fiber to a minichip 310 which will be the flipper. In FIG. 13B the second chip and the rail are prepared by attaching them to the substrate, or the invar and dural elements of a mechanical thermal compensation arrangement as described above. The second chip and the rail need to be mutually aligned using a coarse passive alignment process, for example to within 10-50 microns, depending on the application. This does not require expensive alignment equipment, and is within the range of fine alignment possible with the conventional flipper attachment process if such fine alignment is desired. Profiles or mating profiles in the form of grooves or ridges are formed in the rail, before assembly, for mating with those on the flipper. The mini-chip assembly including the fiber is then “flipped” or laid on the rail by coarse passive alignment as shown in FIG. 13C. If necessary, an active fine alignment is carried out before or during gluing the minichip onto the rail. As shown in FIG. 13D, once aligned, an index matching material can be added to fill the gap between fiber and waveguide. This should be a very low modulus material to tolerate the movement between the dural and invar parts.

FIGS. 14, 15 and 16: Transitional Minichips

FIGS. 14, 15 and 16 show various possible transitional minichips for use in the device or method of FIGS. 12 or 13, or other arrangements. These figures each show a top view and at the right hand end, a cross section or side view to show the grooves. In FIG. 14, an MMI chip is shown which incorporates a multimode section of waveguide. This supports multiple modes which travel at different speeds. This is arranged to result in a double peak intensity profile. This combines with the usual Gaussian profile of the arrayed waveguide to provide a flat topped response for each wavelength in a wavelength multiplexed system. This brings the device closer to the perfect filter response, and so is desirable, even if there is some loss associated with the technique. The chip has longitudinal grooves 400 at each side, for cooperating with corresponding grooves or ridges on a substrate or rail. These can be profiles of any shape, in principle. A central V-groove 410 is provided along a centre line, extending along half the length of the chip from one end, for locating the fiber. The waveguide 420 is provided along the other half of the length of the centre line, aligned with the V-grooves. It has a wider section 430 at an end away from the fiber, for supporting multiple modes. Another section of the waveguide nearer the fiber, has a pair of trenches 440 on either side, converging on the waveguide towards the fiber, for the purpose of minimising degradation of the operation of the MMI section by stripping stray light out of the substrate.

FIG. 15 shows another example of a minichip, this time for interfacing multiple optical paths from fibers or a ribbon fiber, onto a chip. The spacing between the waveguides on the chip is more precise than the spacing between fibers in a ribbon. Hence without this transitional minichip, the fibers of the ribbon need to be separated and individually aligned, which can be expensive and time consuming. This minichip enables the fibers to be aligned passively in the V-grooves of the minichip, and then the minichip can be aligned with the next chip as shown in FIGS. 13A-13D. As well as providing accurate spacing between the waveguides, the chip has tapered sections 450 in each waveguide to provide a smooth transition between the different cross section dimensions of typical fiber core and typical waveguide core. This can help reduce reflections or loss or other degradation, and providing it on the minichip means it does not need to be provided on the next chip. This enables the size of the next chip to be reduced, thus reducing cost, or increasing yield or performance.

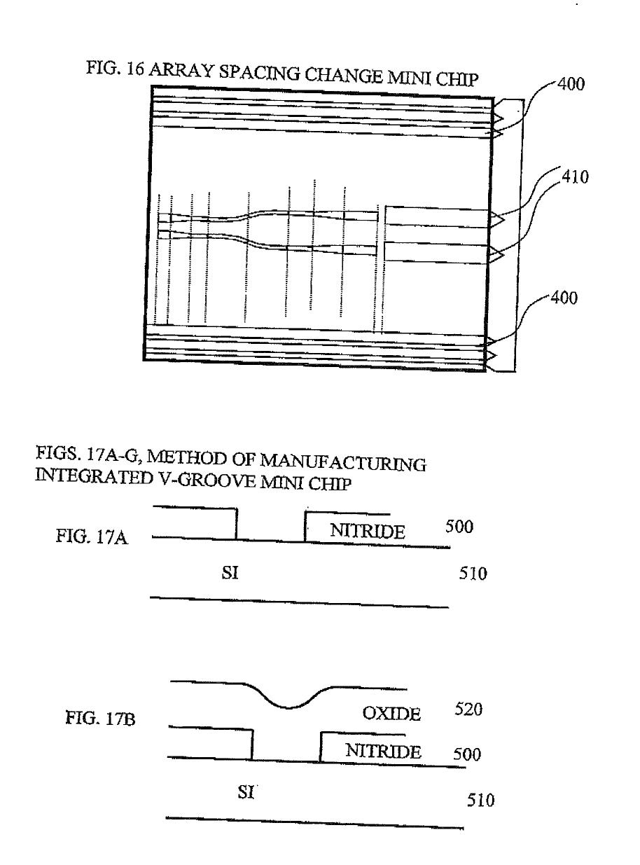

FIG. 16 shows a further example of a minichip, this time for altering the spacing between the optical paths. Again this can help to save space on the next chip and so reduce costs. This is in addition to the advantages set out for the arrangement of FIG. 15.

FIGS. 17A-17G: Manufacture of an Integrated V-groove Minichip

FIGS. 17A-17G show some of the key stages in the manufacture of an integrated V-groove minichip such as those of FIGS. 14 to 16, for use in the devices of FIGS. 11 to 13 or other devices. The new process involves forming a nitride mask 510 fist as shown in FIG. 17A on a silicon substrate 510, (ready for forming V-grooves later by etching). However, this means the oxide layers needed for the waveguide cannot be formed thermally. So they are created as showm in FIG. 17B by depositing an oxide 520 such as undoped silica for example. Then other layers of the waveguide are created in the conventional way. Deposited undoped silica typically forms a poorer quality layer than silica grown by thermal oxidation. This means that the yield is poor which means it is not cost effective for larger chips yet for most applications, even if possible in principle. However it can be cost effective for minichips having a small size or for applications such as transitional optical elements not having sensitive interference or diffraction type elements which require high levels of precision. In such cases, it is not necessary to control this oxide formation process so precisely.

In FIG. 17C on top of the oxide, the core of the waveguide is formed by depositing a layer 530 of the core material and patterning it using conventional processes. As shown in FIG. 17D, a cladding layer 550 is laid above the patterned waveguide core 540 to complete the waveguide, following established practice.

Then the waveguide areas are masked off, and a deep RIE (Reactive Ion Etch) process is used to remove the oxide off the V-groove areas as shown in FIG. 17E. This could give a yield problem for large devices because of risk of punch-through, but is less of a problem for small area devices. Also, because of the limited uniformity of both the undoped oxide deposition and its subsequent removal by RIE, coupled with the poor RIE selectivity between deposited oxide and deposited nitride, an additional HF wet-etch process is used. This is to ensure complete removal of all traces of oxide from over the area of silicon to be subsequently etched to form the v-grooves 560. This HF etch does not compromise the definition of the nitride mask features. But this HF etch is isotropic and will cause undercut in the deposited undoped and doped silica layers that define the PWG structures. This will not matter provided there is sufficient margin provided around the edge of the waveguide areas. Then a wet silicon etch such as KOH (potassium hydroxide), is used for etching the V-grooves according to the nitride mask as shown in FIG. 17F.

Because of the margin required between the V-groove and the waveguide, the waveguide is not exposed and so cannot make a good optical interface with the end of the fiber which will sit in the V-groove. As shown in FIG. 17G, a sawcut is made across the end facet of the V-groove and extending across the margin to expose an end of the waveguide. This sawcut removes undercut margin and leaves a space for a conventional index matching material between the end of the fiber and the end of the waveguide. The sawcut also provides a clean edge where the glue used for fixing the fiber, will stop spreading by capillary action. Alternatively, the undercut structures and the end facet of the v-groove may be removed by deep silicon RIE.

This is the preferred way to achieve a chip to chip coupling and can achieve realistic yield for small chips, e.g. the multimode sections, fan-in and fan-outs, and fiber array spacing clean-up applications shown above.

Other Variations and Concluding Remarks

Other variations will be apparent to those skilled in the art within the scope of the claims. Although arrayed waveguide devices with two star couplers have been described, in principle, the invention can be applied to other optical components, including planar waveguides having echelle gratings in which each waveguide is terminated with a reflective end facet. Other reflective configurations can be used, in each case with appropriate measures such as circulators to separate the incoming and outgoing optical beams. Although described with reference to silica waveguides, other materials may be used. If silicon waveguides are used, since this has a much greater variation with temperature, a much longer extension rod would be needed, and/or an extension rod made of a material such as a polymer material with a much larger expansion coefficient could be used.

Above has been described an arrayed waveguide device having an expansion rod for adjusting a position of the optical paths at a star coupler, by thermal expansion, to compensate for wavelength response dependence on temperature. A bearing surface parallel to a plane of the waveguides prevents movement out of the plane and allow movement along the bearing surface parallel to the plane. Thus small lateral movements can occur accurately without introducing losses through unwanted vertical movements using a passive mechanical arrangement. Active thermal control can be added, to give better compensating accuracy, or compensation for manufacturing variations. An optical component assembly has a substrate having one or more mating profiles, and first and second planar waveguide chips having mating profiles. During assembly, the mating profiles enable passive aliment of an optical coupling between respective waveguides of the chips. A groove locates a fiber on the chip using passive alignment.

1. A planar waveguide device having
one or more optical paths passing through a star coupler, and a set of waveguides having differing optical path lengths extending from the star coupler,
the device also having a moveable part for adjusting a position of one or more of the optical paths at the star coupler, by thermal expansion, to adjust a wavelength response of the device,
the device having a bearing surface parallel to a plane of the waveguides at the star coupler, to prevent movement of the moveable part out of the plane and allow movement along the bearing surface parallel to the plane.

2. The device of claim 1, being an arrayed waveguide device having a second star coupler, the moveable part being arranged to adjust the position of the optical path at one of the star couplers.

3. The device of claim 2, arranged to receive an optical fiber to form one of the optical paths, the moveable part being arranged to move the optical fiber, relative to the first or second star coupler, the movement being transverse to a longitudinal axis of the fiber.

4. The device of claim 1, the moveable part having a planar waveguide chip to form one or more of the optical paths.

5. The device of claim 1, the movement being lateral movement in the plane and perpendicular to the respective optical path, to alter the position of interface of the optical path with the star coupler.

6. The device of claim 5, the amount of the movement by thermal expansion being arranged to cause sufficient change in the wavelength response to compensate for other thermally induced changes in the wavelength response of the device.

7. The device of claim 1, the device having a reference surface for the thermal expansion to act against, to cause the relative movement, and an axial bias arrangement for applying a force along an axis of the movement to bias the moveable part against the reference surface, to overcome mechanical hysteresis associated with frictional resistance to the movement.

8. The device of claim 1, additionally having an active thermal compensation control arrangement.

9. The device of claim 8, an initial set point of the thermal control arrangement being arranged to offset a steady state temperature of the device to compensate for manufacturing variations in wavelength response.

10. A planar waveguide device having
one or more optical paths passing through a star coupler, and a set of waveguides having differing optical path lengths extending from the star coupler,
the device also having a movable part for adjusting a position of one or more of the optical paths at the star coupler, by thermal expansion, to adjust a wavelength response of the device,
the device having a bearing surface parallel to a plane of the waveguides at the star coupler, to prevent movement of the movable part out of the plane and allow movement of the moveable part along the bearing surface parallel to the plane, and a bias arrangement for applying a force to bias the moveable part against the bearing surface.

11. The device of claim 10, arranged to receive an optical fiber to form one of the optical paths, the moveable part being arranged to move the optical fiber, relative to the star coupler, the movement being transverse to a longitudinal axis of the fiber.

12. The device of claim 10, the moveable part having a planar waveguide chip to form one or more of the optical paths.

13. The device of clam 10, the movement being lateral movement in the plane and perpendicular to the respective optical path, to alter the position of interface of the optical path with the star coupler.

14. The device of claim 13, the amount of the movement by thermal expansion being arranged to cause sufficient change in the wavelength response to compensate for other thermally induced changes in the wavelength response of the device.

15. The device of claim 10, the bearing surface extending parallel to a top surface of the waveguide and over a top surface of the moveable part, at a far side of the optical path having greater relative movement.

16. The device of claim 10, the bearing surface being integral with a substrate of the waveguide.

17. The device of claim 10, the bearing surface being angled such that axial expansion causes sufficient movement perpendicular to the axis, to compensate for expansion perpendicular to the axis.

18. The device of claim 10 additionally having an active thermal control arrangement.

19. A planar waveguide device having:
one or more optical paths passing through a star coupler, and a set of waveguides having differing optical path lengths extending from the star coupler,
the device also having a movable part for adjusting a position of one or more of the optical paths at the first or second star coupler, by thermal expansion, to adjust a wavelength response of the device,
the device having a reference surface for the thermal expansion to act against, to cause the relative movement, and an axial bias arrangement for applying a force along an axis of the movement to bias the moveable part against the reference surface, to overcome mechanical hysteresis associated with frictional resistance to the movement.

20. The device of claim 19, arranged to receive an optical fiber to form one of the optical paths, the moveable part being arranged to move the optical fiber, relative to the star coupler, the movement being transverse to a longitudinal axis of the fiber.

21. The device of claim 19, the moveable part having a planar waveguide chip to form one or more of the optical paths.

22. The device of claim 19, the movement being lateral movement in the plane and perpendicular to the respective optical path, to alter the position of interface of the optical path with the star coupler.

23. The device of claim 19, the amount of the movement by thermal expansion being arranged to cause sufficient change in the wavelength response to compensate for other thermally induced changes in the wavelength response of the device.

24. The device of claim 19, the reference surface being integral with a substrate of the waveguide.

25. The device of claim 19, the axial bias arrangement having an elongate fixing member having a tapered surface for fitting through a hole having a corresponding tapered surface, so as to fix an end of the moveable part relative to the reference surface, and arranged such that the hole is offset to cause the axial bias of the moveable part against the reference surface by deformation of the fixing member.

26. The device of claim 19, additionally having an active thermal control arrangement.

27. The device of claim 19 having a bearing surface parallel to a plane of the waveguides at the star couplers, to prevent movement of the moveable part out of the plane and allow movement along the bearing surface parallel to the plane.

28. An optical component having an optical path that varies with temperature and having an adjuster, the adjuster having
a movable portion of the optical path,
an expansion member coupled to the moveable portion to move it by thermal expansion, relative to a reference surface,
a guide for guiding the movement of the expansion member, and
a bias arrangement for biasing the moveable portion against the guide.

29. A method of operating an optical telecommunication network to offer a telecommunications service to subscribers by transmitting optical signals along an optical path passing through the optical component of claim 1.

30. An optical component assembly having:
a substrate having one or more alignment profiles, and
first and second planar waveguide chips mounted on the substrates,
at least the first of the planar waveguide chips having:
one or more alignment profiles corresponding to those on the substrate for cooperating with the alignment profiles on the substrate, for alignment of an optical coupling between respective waveguides of the first and second planar waveguide chips, and
a groove for locating a fiber for providing an optical coupling to or from the assembly.

31. The assembly of claim 30, the first chip having waveguide elements which are all sufficiently short or simple that they are not susceptible to variations across different areas of the chip, of a propagation constant of the waveguide, such variations being sufficient to cause degradation of precision interference or diffraction effects relying on long optical paths across the different areas of the chip.

32. The assembly of claim 30, the second of the planar waveguide chips having one or more optical paths passing through a star coupler, and a set of waveguides having differing optical path lengths extending from the star coupler.

33. The assembly of claim 32, also having a moveable part for adjusting a relative alignment of the and second planar waveguides to adjust the position of one or more of the optical paths at the star coupler, by thermal expansion, to adjust a wavelength response of the assembly.

34. The assembly of claim 33, having a bearing surface parallel to a plane of the waveguides at the star couplers, to prevent movement of the moveable part out of the plane and allow movement along the bearing surface parallel to the plane.

35. An optical flat-topped filter arrangement having:
an arrayed waveguide chip for multiplexing or demultiplexing a wavelength division multiplexed (WDM) signal, and having a star coupler,
a second chip incorporating a multimode (MMI) section coupled in series with the arrayed waveguide, and providing a spatial power distribution that convolves with that of the arrayed waveguide to give a flat-topped overall response for each of a number of WDM channels, and
a passive mechanical thermal compensation arrangement for providing a thermal expansion-driven relative movement between the arrayed waveguide chip and the MMI chip, to shift a location of an input or output to the star coupler of the waveguide, so as to shift its frequency response.

36. The arrangement of claim 35, the MMI chip having one or more alignment profiles for cooperating with corresponding alignment profiles on a substrate of the thermal compensation arrangement, for alignment during assembly.

37. The arrangement of claim 35, the MMI chip having a groove for locating a fiber for providing an optical coupling to or from the assembly.

38. An optical waveguide assembly having an arrayed waveguide, and a transitional waveguide coupled optically to the arrayed waveguide and mounted on separate chips on a substrate and having a passive athermalisation arrangement for the arrayed waveguide.

39. The assembly of claim 38, the athermalisation arrangement having a moveable part for adjusting a lateral alignment of the separate chips by thermal expansion, to adjust a wavelength response of the arrayed waveguide.

40. The assembly of claim 39, the transitional waveguide being mounted on the moveable part, the transitional waveguide and the moveable part having mating profiles for passive alignment during assembly.

41. A method of assembling an optical component assembly having a substrate, and first and second chips each having waveguides, the first of the chips having one or more first mating profiles, for mating with one or more second mating profiles on the substrate or on a spacer or movable part attached to the substrate the method having the steps of:
attaching the second chip to the substrate, with a coarse alignment process, to align the second chip with the second profiles and
making a coarse alignment of the first chip with the second chip by mating the first and second mating profiles.

42. The method of claim 41, additionally having the step of attaching a fiber to the first or the second chip, using an alignment groove on the respective chip to locate the fiber for passive alignment with the waveguide of the respective chip.

43. The method of claim 41, additionally having the step of carrying out a fine active alignment process for the first and second chips when attaching the first chip to the substrate or spacer or moveable part.

44. The method of claim 41, the first chip having waveguide elements which are all sufficiently short or simple that they are not susceptible to variations across different areas of the chip, of a propagation constant of the waveguide, such variations being sufficient to cause degradation of precision interference or diffraction effects relying on long optical paths across the different areas of the chip.

45. A method of manufacturing a planar waveguide having one or more integrated profiles for alignment of the waveguide with a fiber or another waveguide, the method having the steps of:
forming a first mask on a substrate, the first mask being patterned for later forming the integrated profiles,
forming waveguides on a different part of the substrate,
uncovering the pattern of the first mask by etching using a reactive ion etching (RIE) type etching step and a fine wet-etching step, and
forming the integrated profiles through the first mask.

46. The method of claim 45 the step of forming the waveguides having the step of forming oxide layers using a deposition process.

47. The method of claim 46, the step of forming the waveguides involving leaving a margin between an edge of the waveguides and a facing edge of the pattern for the integrated profiles.

48. The method of claim 47, further having the step of removing part of the margin to expose an end of the waveguide facing one of the integrated profiles to enable optical coupling between the end and an optical fiber laid in that profile.

49. The method of claim 48, the removing step involving a sawcut or an etching step.

50. The method of claim 49, the removing step also conditioning an end of the integrated profile facing the end of the waveguide.

51. The method of claim 48, further having the step of attaching the fiber in the profile.

52. The method of claim 46, further having the step of using the integrated profile to align and attach the chip to a corresponding profile on a substrate.

53. A method of manufacturing a planar waveguide having one or mow integrated profiles for alignment of the waveguide with a fiber or another waveguide, the method having the steps of:
forming a first mask on a substrate, the first mask being patterned for later forming the integrated profiles,
forming waveguides on a different part of the substrate leaving a margin between an edge of the waveguides and a facing edge of the pattern for the integrated profiles,
forming the integrated profiles through the first mask, and
removing part of the margin to expose an end of the waveguide facing one of the integrated profiles to enable optical coupling between the end and an optical fiber laid in that profile.

54. The method of claim 53, also having the step of conditioning an end of the integrated profile to enable the optical coupling.

55. A method of manufacturing a planar waveguide having one or more integrated profiles for alignment of the waveguide with a fiber or another waveguide, the method having the steps of:
forming a first mask on a substrate, the first mask being patterned for later forming the integrated profiles, and being formed of a material capable of withstanding etching and high temperature processing,
forming waveguides on a different part of the substrate, by depositing oxide layers over the nitride layer,
uncovering the pattern of the first masks and
forming the integrated profiles through the first mask.

56. The method of claim 55, the first mask material being nitride.
